(19) United States
(12) Patent Application Publication
(10) Pub. No.: US 2004/0039465 A1
(43) Pub. Date: Feb. 26, 2004

(54) Modular tooling approach to major structural repair

(76) Inventors: Larry Paul Boyer, St. Charles, MO (US); Greg Knaus, Warrenton, MO (US); Matt McGrory, St. Louis, MO (US)

Correspondence Address: Mark L. Lorbiecki, Esq., BLACK LOWE & GRAHAM PLLC, 816 Second Avenue, Seattle, WA, 98104, US

(21) Appl. No.: 10/226,977

(22) Filed: Aug. 23, 2002

(51) Int. Cl. G06F 19/00; G06F 17/00; G05B 13/02; G06G 7/48

(52) U.S. Cl. 700/95; 700/90; 700/97; 700/30

(57) ABSTRACT

A controller for modular tooling includes a central processing unit. A scanner port is configured to establish and maintain communicative connection between an optical scanner and the central processing unit. A database is in communicative connection with the central processing unit. The database includes at least one numeric model of an aircraft, assembly, sub-assembly or component part; at least one standardized procedure for a repair of an aircraft, assembly, subassembly or component part; and a tooling library containing operating characteristics of at least one controllable tool. An effecter port is configured to establish and maintain communicative connection between a controllable tool and the central processing unit. An operator interface is in communicative connection with the central processing unit.

### FIELD OF THE INVENTION

This invention relates generally to aircraft tooling and, more specifically, to automated aircraft tooling.

### BACKGROUND OF THE INVENTION

Airplanes cannot fly in a vacuum. They take what they find in the atmosphere. From the moment they leave the factory runway, they are at risk for bird strikes, hail, turbulence, and dust. On the ground, they risk collision with any number of obstacles, including the ground itself. An overly hard landing may result in damage to the gear, the wingtips, and the hatches, as well as any antenna. Many will need repair to keep them in their optimum flying condition. Some of them will require major structural repair.

On the factory floor, the airframe is formed with great attention to the dictates of the high performance profiles of the wings, the fuselage, and the empennage. Tooling such as drilling, boring, reaming, riveting, trimming, and grinding require the strictest control to maintain the design engineering responsible for the performance of the airframe. Traditionally, hard tooling is fabricated to accurately locate parts. Consisting of jigs, benches, and templates, these tools are dedicated to precisely the model and revision currently under construction. Any revision to the model requires a revision to the hard tooling.

The theory of hard tooling is simple. The jig is the foundation of the tooling. The jig is a heavy steel weldment, generally anchored in the factory floor. The jig is built to strict tolerances and regularly routined—measured to account for any movement of the jig surface due to either wear or temperature changes. The jig provides the absolute benchmark for all part placement as the wing is built up. As ribs are formed on one jig, they are delivered to the master jig for placement. Templates fit onto the jig and rest on the surface of the fuselage to locate each part or subassembly. Every hole is drilled in reference to benchmarks on the jigs, and every rivet fits into every hole because they were referenced to the jig.

As before, once the airframe leaves the factory and enters into service, the airframe is at risk for damage. The jig is in the factory, if it still exists at all. Any repair beyond a simple pulling of a dent or replacement of a part in the same holes requires some sort of guidance to maintain the strict tolerances that lend performance to the airframe. Neither commercial airframes nor high performance military airframes are well-suited to “eyeballing.”

The industry has answered this need in two ways. The first is to duplicate the factory jigs at depots dedicated to the repair of the airframe. Just as costly as the original, these jigs may be poorly suited for repair rather than construction. In many ways, they are often more elaborate than necessary for major structural repair.

To see the shortcomings of use of the construction jig for repair, examine the case of a landing gear in need of repair. Where a landing gear is placed within a well in the wing, usually neither the skin, nor many structural details depending from the skin are in place. From the jig to the gear, measurements are easily taken. Templates can span the distance from jig to gear assuring accurate part placement. With permanently installed skin in place where the template might rest, it is difficult to draw accurate placement information from the jig for the repair placement of the gear.

The second way is slightly different but still based upon jigs. Mindful of the differences between production and repair, manufacturers have produced distinct tooling based upon the original jigs but meant for a given repair. Under the names Alignment Kits or Repair Equipment, depending upon the repair task the kit is to address, the kits duplicate the alignment of the original tooling but accommodate known approaches to well defined repairs. Alignment Kits duplicate master tooling to allow customer re-certifications of their repair equipment that are similar to production assembly jigs and fixtures. Repair Equipment must be oversized and have adjustment capabilities to accommodate a less than nominal structure (production tooling need only accommodate the off-the-shelf configuration of the workpiece). In either embodiment, the repair tooling is as expensive to design and to fabricate as the original hard tooling.

Customers order and manufacturers design, fabricate, and ship hundreds of REs (Repair Equipment) or AKs (Alignment Kits) to meet perceived repair needs. Generally, because aircraft are expensive capital assets, and because they must generate income streams to be profitable, the customer will do all it can to minimize the time of the “AOG” state, i.e. the aircraft is on the ground or in military terms “hard down.” To that end, customers will order kits built for the repair contingency that often go unused for the life of the aircraft. For example, for a military customer, the repair tooling can often cost over $100 million. These costs are hard to amortize over life of airframe. While in storage, the tools often degrade, as they await use.

In recent years, the several manufactures of aircraft have embraced computers for design work. One of the great strengths of the computers is to project designed parts, sub-assemblies, assemblies, and even airframes into three-dimensioned space. To the extent that they are used, jigs are smaller and quickly formed by computer through computer numerical control (CNC). On the production floor, manufactures have even done away with the jig in favor of computer-controlled production. To date, repair has been a much harder task to computerize because damage does not occur the same way each time.

Many companies today employ industrial robots to do manufacturing tasks. However, the ability to accurately position end-effecters by these robots has been limited, due to lack of suitable feedback, and therefore their use has been restricted to doing only repetitive tasks.

To date, skilled operators perform many of the tasks of current production tooling either by marshalling autonomous robots or by remotely controlling, semi-autonomous tooling. Today's industrial robots and tooling are generally precise, but rarely accurate within tolerances necessary for aircraft production. The tools may place their end-effectors (the “fingers”) time after time in the same spot with little variation. Once a robot has been taught a series of movements needed to complete a particular job, it can repeat this path over and over, with small variations from one repetition to the next. But these models are imperfect: such things as mechanical friction, temperature, and mechanical wear make it virtually impossible to determine positions to accuracies of a thousandth of an inch. To compensate for this limitation, manufacturers take advantage of the robots' repeatability. They do this by using a special fixture, or jig, for each machining operation; the jig keeps the workpiece in precise registration with the robot path. These fixtures are extremely expensive, especially in the aircraft industry, where workpieces are large.

In order to meet the needs of production manufacturers, the automated tooling needed a feedback loop to assure accuracy. Industry has turned to two complementary technologies to guide its automated tooling: the laser tracker survey and photogrammetry. The laser tracker survey requires the use of an industrial laser tracker. From one point, the laser scans the surface of a workpiece and develops a spherical projection of the workpiece in three-dimensioned space, i.e. locating each point of the surface in terms of azimuth, elevation, and distance. Photogrammetry is the art, science, and technology of obtaining reliable information about physical objects and the environment, through processes of recording, measuring, and interpreting images and patterns of electromagnetic radiant energy and other phenomena. From accurate measurement of images from a plurality of cameras, an object is placed in three-dimensioned space. Both of these technologies are readily available from such manufacturers as Leica™ and DVT™ in commercial-off-the-shelf packages.

Whereas the former system based tolerance on distances and angles from the jig to the tool head and from the jig to the workpiece, the computer has removed the reliance upon the jig for all accuracy. Rather than building all “tool-to-workpiece” relationships from “tool-to-jig” and “jig-to-viorkpiece” relationships, the computer locates the tool head and the workpiece, be it wing, fuselage, or empennage, in absolute space, and having located each, applies the tool to the workpiece with previously unachieved precision. Rather than to cascade tolerances (reflecting wear between the jig and the template, wear within the locating hole in the template, wear on the cutting tool, etc.), the computer, to the extent that it is aware of the precise position of tool and workpiece, reduces the build up of cascading tolerances present in hard tooling.

Repair is not manufacturing. As is noted above, the airframe is not in its nominal condition when it comes to the repair depot. Wings do not crumple in fixed and predictable manners. The nature of the damage dictates the nature of the repair. Production tooling always faces the same problem each time it is used. Repair machinery requires a far broader scope. Three problems exist then: where is every bit of the airframe; where should it be; how best to get it there.

There exists, then, an unmet need in the art for an automated means of repairing major structural damage. The need is for a flexible platform that is adaptable to the damage for which repair is sought without requiring jigs.

### SUMMARY OF THE INVENTION

The present invention provides a portable modular tooling platform readily adaptable for any major structural repair. The invention also provides a controller for modular tooling. In one exemplary embodiment the controller includes a central processing unit. A scanner port is configured to establish and maintain communicative connection between an optical scanner and the central processing unit. A database is in communicative connection with the central processing unit. The database includes at least one numeric model of an aircraft, assembly, sub-assembly or component part; at least one standardized procedure for a repair of an aircraft, assembly, sub-assembly or component part; and a tooling library containing operating characteristics of at least one controllable tool. An effecter port is configured to establish and maintain communicative connection between a controllable tool and the central processing unit. A operator interface is in communicative connection with the central processing unit.

By using digital rather than hard tooling to direct the several robotic tools necessary for major structural repair, depots will be able to handle a large variety of airframes. Where there exist digital models of the airframes, the invention can exploit the models for guidance. Where no such models exist, in most cases, the bilaterally symmetric nature of most airframes will allow the invention to survey the undamaged side of the invention; perform a mirror transform; and exploit the transform for guidance on the invention. Similarly, where a piece of an airframe has a constant cross-section, the survey to either side of the damage will guide the invention.

The invention suitably entails the use of modular pieces, all normalized for the controller. For example, Alufix™ is suitable a modular fixturing system made out of high-tensile aluminum for measuring fixtures, checking gauges, assembly or welding fixtures, cubings, gauges within the system. Because the Alufix™ can be assembled to meet the needs of a given repair, an embodiment of the inventive system is readily adapted to the workspace.

One embodiment of the invention is portable and reconfigurable. No one component of the invention weighs more than 40 pounds. Once the fixtures are assembled to the task, the repair is readily performed with such modules as are necessary to assure appropriate tolerances. Having performed the repair, the tools are removed and the fixtures knocked down for the next repair.

### BRIEF DESCRIPTION OF THE DRAWINGS

The preferred and alternative embodiments of the present invention are described in detail below with reference to the following drawings.

FIG. 1 is a flowchart depicting steps to repair a damaged aircraft;

FIG. 2 is an information flow diagram of the invention;

FIG. 3 is a partial perspective and schematic view of a laser tracker used in conjunction with the controller;

FIG. 4 is a perspective view of a laser tracker surveying a fixture;

FIG. 5 is a block diagram of an invention assembled to control fixturing of an aircraft;

FIG. 6 is a perspective view of a laser tracker surveying a fixture with an aircraft secured thereon;

FIG. 7 is a perspective view of a laser tracker surveying a fixture with an aircraft secured thereon along with a sensor, and a controller;

FIGS. 8-9 are screenshots from the graphic user interface on the controller;

FIG. 10 is a perspective view of a trailing edge flap shroud being surveyed by a laser tracker;

FIG. 11 a perspective view of a trailing edge flap shroud being repaired while observed by a laser tracker;

FIG. 12 is a perspective view of a main landing gear, aft trunnion fitting;

FIG. 13 is a perspective view of an in-line power tool and accompanying bearings;

FIGS. 14a-15b show a perspective view of a forward drive half of a semiautomatic series in-line drive on a fixture;

FIG. 16 shows perspective views of options for mounting a modular fixture for suspending a semi-automatic series in-line;

FIGS. 17-18 show a semi-automatic series in-line drive suspended on an on a fixture in position to grind the main landing gear, aft trunnion fitting; and

FIG. 19 shows a perspective view of a laser tracker monitoring the movement of a semi-automatic series in-line as it operates to grind the main landing gear, aft trunnion fitting.

### DETAILED DESCRIPTION OF THE INVENTION

The invention is a modular approach to configuring tools suitable for major structural repair. By way of overview, the present invention includes a controller for modular tooling. The controller includes a central processing unit. A scanner port is configured to establish and maintain communicative connection between an optical scanner and the central processing unit. A database is in communicative connection with the central processing unit. The database includes at least one numeric model of an aircraft, assembly, sub-assembly or component part; at least one standardized procedure for a repair of an aircraft, assembly, sub-assembly or component part; and a tooling library containing operating characteristics of at least one controllable tool. An effecter port is configured to establish and maintain communicative connection between a controllable tool and the central processing unit. A operator interface is in communicative connection with the central processing unit.

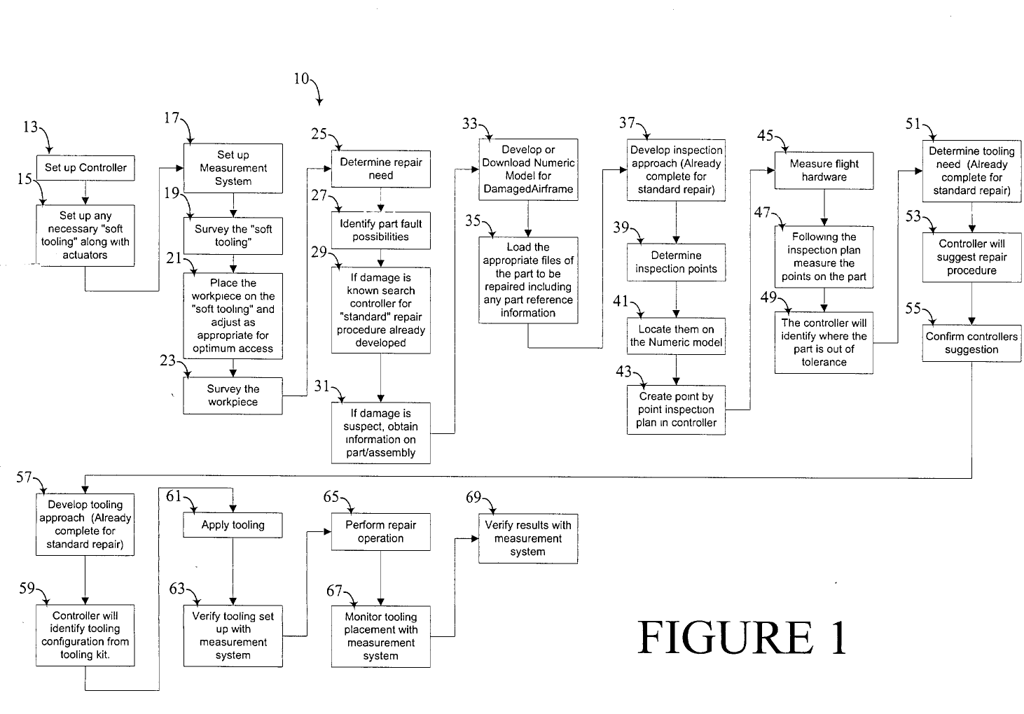

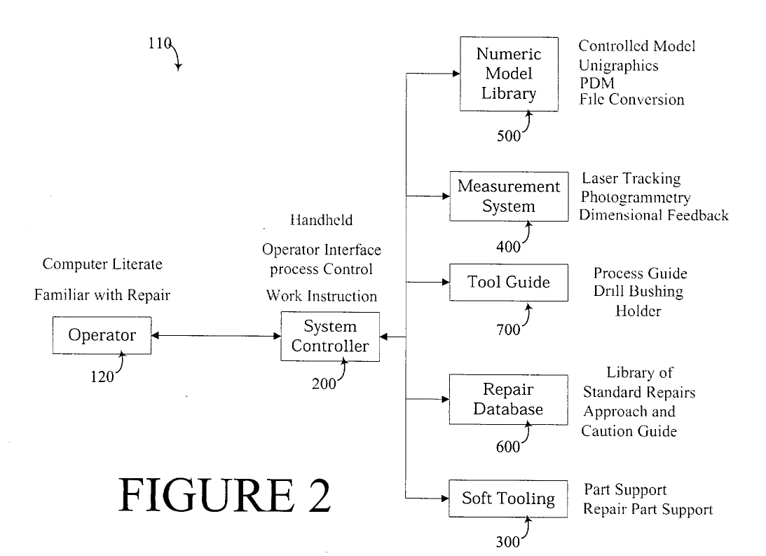

Referring now to FIGS. 1 and 2, exemplary method of using the controller 200 for major structural repair is discussed. FIG. 1 is a flowchart depicting an exemplary method 10 of repair using the controller 200 with a measurement system 400. At a block 13, the controller 200 is set up at a repair site. Generally, the controller 200 is suitably a computer processor coordinating input and output signals from six peripheral areas depicted in FIG. 2: an operator interface 120; “soft tooling” 300, such as without limitation an adjustable jig, generally fabricated from modular components and adjustable actuators in communication with the controller 200; the measurement system 400, including without limitation laser tracking and industrial video cameras; and three database functions that may be either distinct or grouped which are: a numeric model library 500 suitably containing models of various aircraft; a repair database 600 suitably containing a compendium of known repair techniques for various airframes or families of airframes; and a tool guide 700 suitably containing information on a variety of tools controllable by the controller 200, including without limitation normalization data, clearances for use, and suggested approaches for use in various airframes. Indeed, these databases may be kept on a remote server allowing the controller access as necessary. The controller 200 is set up in a manner to be accessible to each of the appropriate systems, while far enough out of the way to allow operation.

Once the controller 200 is in place, a determination is made of “soft tooling” to be used. As used herein, the term “soft tooling” means an adjustable jig or gantry for holding a workpiece, be it an airframe, an assembly or sub-assembly, or part. “Soft” refers to the adjustable nature of the jig or gantry. The soft tooling suitably includes, without limitation, various components from the Alufix™ line, or functional equivalents, and various actuators responsive to the controller 200. Within the tool guide database 700, there will generally exist a recommended configuration, though nothing limits the operator to the recommended configuration.

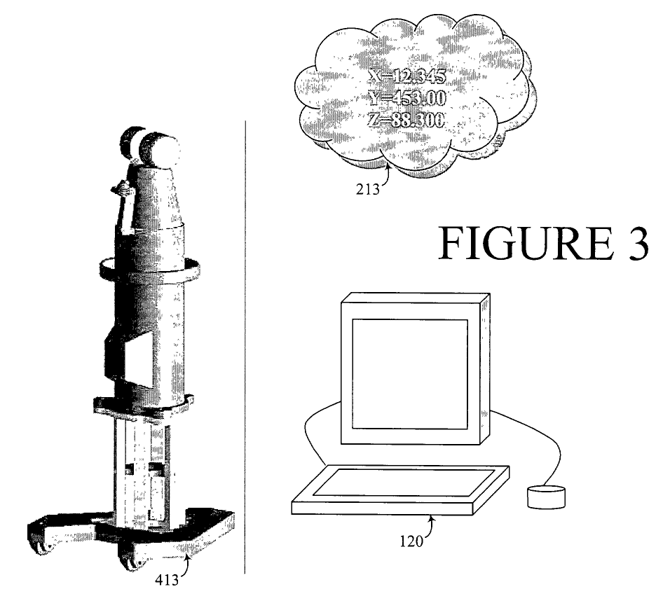

At a block 15, the “soft tooling” is suitably set up according to an operator's informed judgment based upon the suggested configuration from the tool guide 700. At a block 17, the measurement system is set up. Referring now, additionally, to FIG. 3, the controller 200 (FIG. 2) through the operator interface 120 assigns a location to the laser tracker 413 in three-dimensioned space with appropriate coordinates 213. The coordinates 213 of the laser tracker 413 may suitably be arbitrary coordinates, but the coordinate 213 set the frame of reference for all other objects within the frame of reference.

Laser-tracker sensors have recently been developed that make it possible to measure the position of a reflector on a robot's moving end with great accuracy. A laser-tracker sensor made by Leica™ that measures position to within 25 and 250 micrometers for stationary and moving targets, respectively. A well-placed industrial video camera, such as a pair of DVT™ Series 600 can achieve stereoptic location with accuracies that are slightly coarser but still industrially useful. Exploiting either of these vision systems to observe and to accurately place the workpiece and the tool in three-dimensioned space allows a controller to position automated tooling on a workpiece with accuracy sufficient to repair or replace damaged parts on an airframe.

A measurement system 400, may either be a dedicated processor or software for photogrammetry within the general tooling program. The system collects information from either the laser tracker 413, with information garnered from one or more industrial video cameras 417, or a combination of the two. Two suitably placed industrial video cameras will develop accurate three-dimensioned special models. In high-precision teleoperation, high-resolution visual depth information may be critical, thus requir-ing vision system capabilities quite different from lower precision teleoperation vision systems. Several possible approaches to providing this depth information are available. Multiple-camera television systems, 3-D television systems, and 3-D video graphics systems all have advantages and disadvantages. Multiple camera TV systems provide depth information by providing several views of the workspace. For a static subject, panning a camera across the field of interest will provide the same effect. When combined with a laser survey, the level of precision is entirely consistent with precision machining.

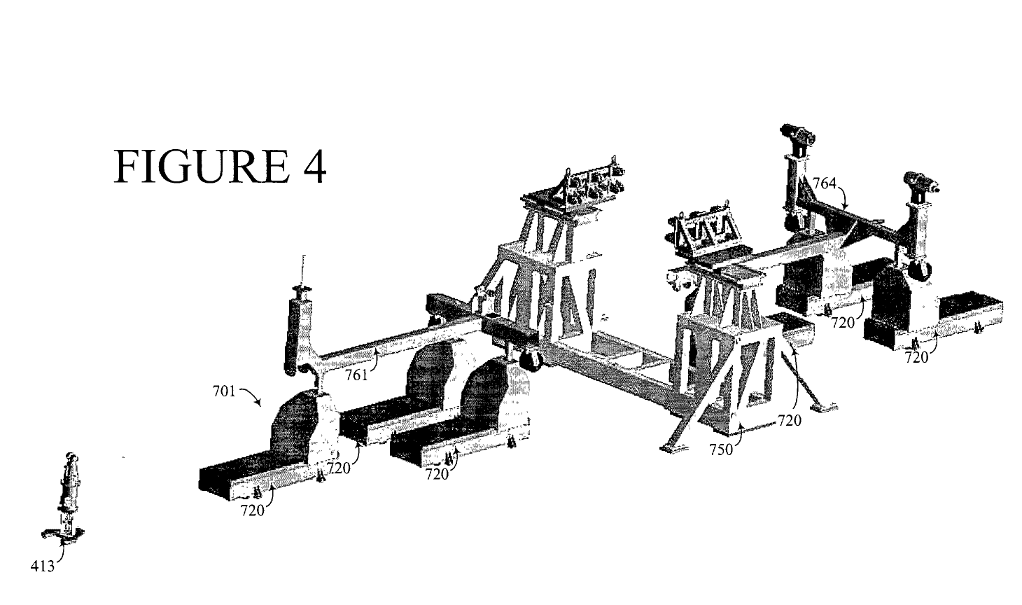

Once the measurement system 400 is set up, the “soft tooling” is surveyed at a block 19. “Soft tooling” 701 for an aircraft and the laser tracker 413 suitably appear, generally, as set forth in FIG. 4. The “soft tooling” 701 may comprise several already existing components at the repair depot. For example, a standard center barrel fuselage fixture 750, two standardized weldments 741 and 744 (each of which are suitably dollies in common use at the depot) are placed upon three robotic “three axis” jacks 720 each. With the fixture 750, the weldments 741 and 744, and the jacks 720 in place, the “soft tooling” 701 for the aircraft, such as without limitation an F/A-18A/B/C/D is complete and can be configured for receiving the airframe (not shown). With set up of the “soft tooling” 701 complete, at the block 19 the operator (not shown) orders the laser tracker 413, through the operator interface 120 (FIG. 3), to survey the “soft tooling” 701 thereby locating it in three-dimensioned space.

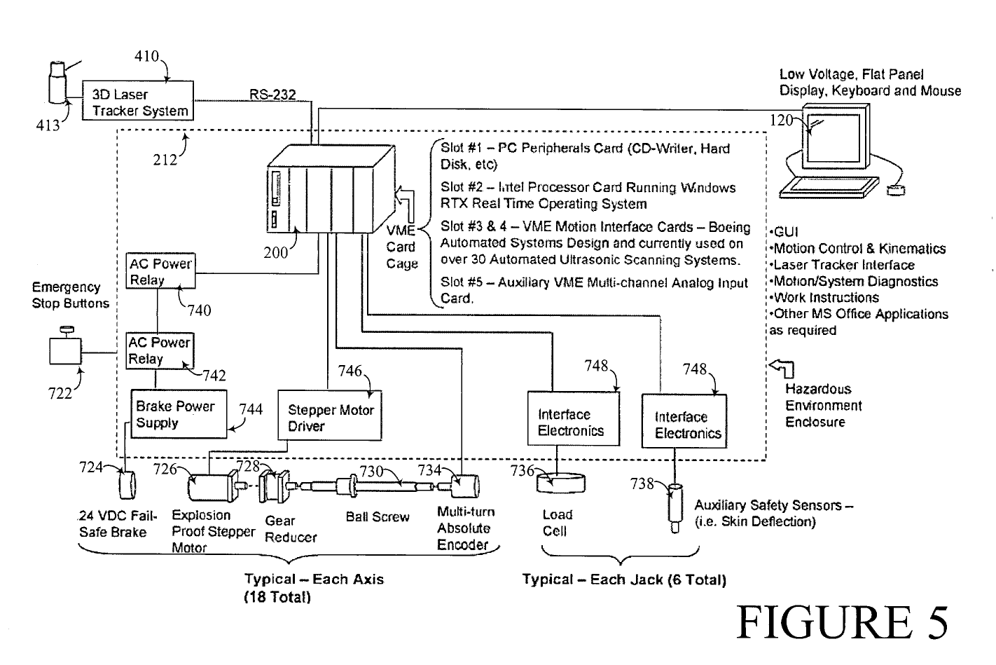

Upon connection of the jacks 720, the wiring diagram for the system appears as set forth in FIG. 5. The “soft tooling” 701 is controlled by the controller 200 as directed by the operator (not shown) through the operator interface 120 and guided by the three-dimensioned laser tracking system 410 controlling the laser tracker 413. Each of the robotic “three-axis” jacks 720 control the displacement of the jack lifting-pad (not shown) in the x-, y-, and z-axes. Each of the jacks suitably has an emergency stop button 722 to allow the operator or any observer to prevent any damage to the airframe based upon the displacement of the jack lifting-pad into the airframe.

Each axis of the jack 720 is controlled by a controlled screw including a fail-safe brake 724, an explosion-proof stepper motor 726, a gear reducer 728, a ballscrew 730, and a multi-turn absolute encoder 734. The controller 200, sends a signal through the stepper motor driver 746, to drive the stepper motor 726. The gear reducer 728 steps down the number of turns of the ballscrew 730 for each turn of the stepper motor 726 yielding a greater mechanical advantage to the stepper motor 726. The multi-turn absolute encoder 734 counts the number of turns and fractions of turns of the ballscrew 730, providing feedback to the controller 200, allowing the controller 200 to accurately locate the jack lifting-pad (not shown) along the axis in question. The fail-safe brake 724 receives power through cascaded power relays 740 and 742, through a brake power supply 744. Either the controller 200 or the emergency stop button 722 will activate the brake.

A load cell 736 on the jack lifting-pad feeds back the load on the individual jack 720 to the controller 200, through interface electronics. The airframe (not shown) is further protected by a number of auxiliary safety sensors (e.g. skin deflection sensors proximate to the point of contact between the jack and the airframe) that are fed through interface electronics as well. These sensors suitably indicate any undue load placed at any cradle point on the airframe (not shown). A hazard environmental enclosure 212 may house the whole of the components related to the controller 200 as shown if desired.

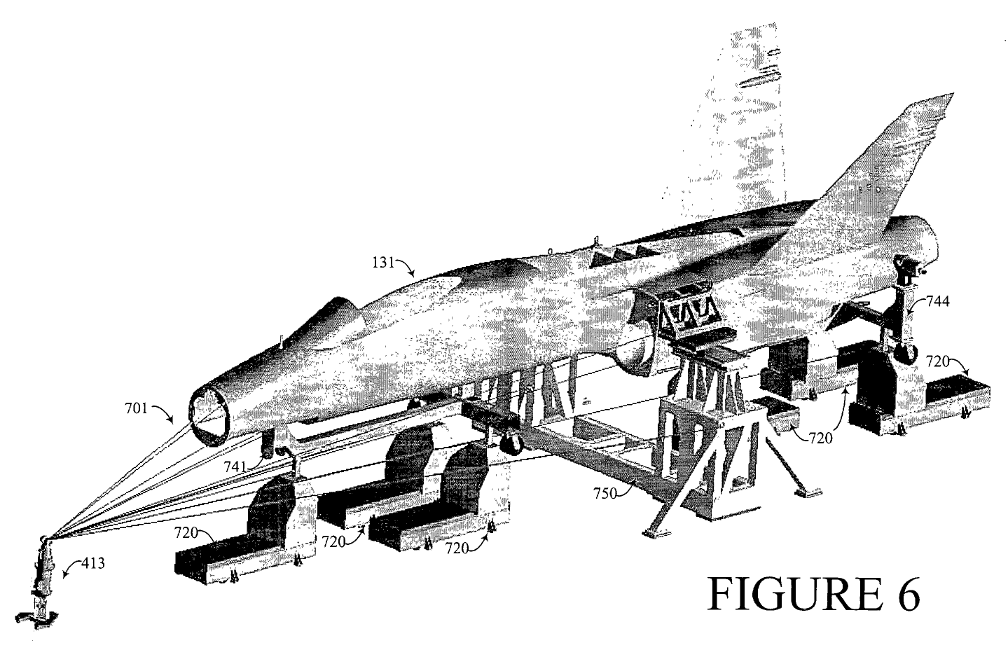

Once the “soft tooling” 701 and the electrical connections to the “soft tooling” 701 are appropriately set up, at a block 21 a workpiece, such as an airframe 131, is set in place on the “soft tooling” 701. As shown in FIG. 6, at a block 23 the controller 200 orders the laser tracker 413 to survey the airframe 131 on the “soft tooling” 701. The operator controls the “soft tooling” through the operator interface 120. By receiving position information from the laser tracker 413, and by the load cells 736 indicating weight borne by each of the jacks 720, the operator can most evenly distribute the weight of the airframe 131 as the airframe 131 is set in place. Once in place, the survey of the airframe indicates exactly where the airframe sits in three-dimensioned space. The result of the survey is a full numeric representation of the airframe 131 in space, as it now exists.

Having surveyed the airframe 131, at a block 25 the operator now turns to defining a zone of any damage. Where replaceable parts solely bear the brunt of the damage, the operator notes that at a block 27. Where, instead of replaceable parts, the damage is confined to a definable zone, the operator enters the airframe type and the description of the damage at a block 29. Finally, if there are sections of the airframe or 131 a part for which there is a suspicion of additional damage, the operator notes the additional damage at a block 31. Now, the questions have been appropriately entered into the controller 200 for a meticulous survey of the airframe 131.

To effect the major structural repair, the controller 200 compares the actual airframe to the idealized airframe as designed. For this, the controller 200 develops an idealized airframe at a block 33. A presently preferred embodiment of the invention allows for at least two distinct methods of developing an idealized model of the airframe 131 for comparison to the full numeric representation of the airframe 131 in space, as it now exists.

The first method occurs where there exists a numeric representation of the airframe as manufactured. Often the source of such a representation will be the manufacturer. Catia™, Unigraphics™, and Autocad™ representations are commonly generated in the course of manufacturing an airplane. These can be obtained from the manufacturer for the purpose of structural repair and are loaded at a block 35.

Where no such model currently exists, the repair entails the development of an inspection approach at a block 37. In such a case, there are several sources of information. Aircraft are, by nature, generally bilaterally symmetric. On each aircraft, generally, except along the centerline, there exist two examples of each structure. Thus, allowing the controller 200 to survey the corresponding structure and then to transform the resulting model by using a mirroring mathematic transform mirroring the structure along an axis parallel to that of the airframe, thereby orienting the structure for comparison with its corresponding damaged structure. Other such methods exist, as well. In either military or commercial settings, it is not unusual to have access to several representations of a single series of a single model of a particular aircraft. Scanning with the laser tracker 413, an undamaged aircraft can easily provide an exemplar for the damaged structure. Where a wing or other structure has constant profile, scanning an area adjacent to the damage that is not, itself, damaged, will yield an appropriate model for comparison.

In each instance where a real example is used for comparison, the real example might be enhanced by modeling techniques, such as dropping “splines” (a mathematical function that is defined on an interval, is used to approximate a given function, and is composed of pieces of simple functions defined on subintervals and joined at their endpoints with a suitable degree of smoothness across the example) across the real example to further define the example. The real example may include certain well-defined parts that the controller 200 can readily substitute for the scan of that part on the example. All of these techniques, and others known in the art, may be applied to refine the exemplar derived by scanning a real aircraft with a laser tracker 413.

Once a fully developed exemplar exists along with the model developed from the scan of the damaged aircraft, a comparison that is given meaning by the controller 200 comparing the three-dimension model resulting from the scan of the damaged aircraft with the three-dimensioned model exemplar. It will be appreciated that accuracy of the comparison is enhanced by minimizing any difference in orientation between the two models. In some instances, the model of the damaged aircraft may be easily overlain on the exemplar and the damage readily detected by the difference. In other cases, the controller 200 may be assisted by help of the operator to complete the overlay. Generally, this help is in the form of a constellation of inspection points.

The use of inspection points as a means of registering a template with a workpiece is known in the art. Aircraft manufacturers have regularly placed “golden rivets” on the airframe as benchmarks to allow location of holes, parts, assemblies and sub-assemblies. A group of anodized gold colored rivets at appropriate points on the airframe allow rapid and ready location of pertinent components. Similarly, every feature of the airframe is addressable in both the exemplary numeric model and the scanned model of the damaged airframe. On a wing, each spar, each rib, and each stringer provide a reference point. Every rivet is located on a numeric model of the airplane. A scanned model will also locate rivets.

Selecting a series of the features on the scanned model at a block 39 nominates benchmarks for the comparison. The operator then identifies, at a block 41, from among the nominated benchmarks, those benchmarks that will serve as designated inspection points on the numeric model facilitating the comparison. From there the operator creates a point-by-point inspection plan in the controller at a block 43. If the damage evokes a standard repair, the inspection pattern is known and readily applied. The controller 200 then directs the laser tracker 413 at a block 45 to measure the existing damaged portion of the airframe. The laser moves from point to point, following the inspection plan as set forth at a block 47. At each point, the controller 200 determines whether the part is within or outside of the designated tolerance at a block 49.

Upon completion of the inspection, determining the nature and the extent of the damage, the operator works in conjunction with the controller to determine the extent of the damage and proposes a tooling plan. Distinct damage will require distinct tooling plans. For some damage, the end-effecter will apply a forging action to bend components back into shape. For other damage, cutting the damaged skin from the airframe is appropriate. For several rotational parts, regrinding and bushing may be the appropriate fix. For some well-known repair procedures, the tooling needs are already defined at a block 51. Where the tooling needs are not defined, at a block 53 the controller 200 will suggest some alternate plans through which the steps and tools appropriate to repair the measured damage. The operator, at a block 55, will select from among the offered repair plans or facilitate the construction of a repair regimen.

In the course of generating a repair plan, in a block 57 the controller will suggest tools. Additionally, at a block 59, the controller 200 will suggest an appropriate modular fixture configuration to deliver and support the tooling in appropriate relation to the workpiece 131. The controller 200 also suggests the appropriate tooling 701, the fixture to support the tooling 701, and the approach to bring the tooling 701 appropriately to the workpiece 131.

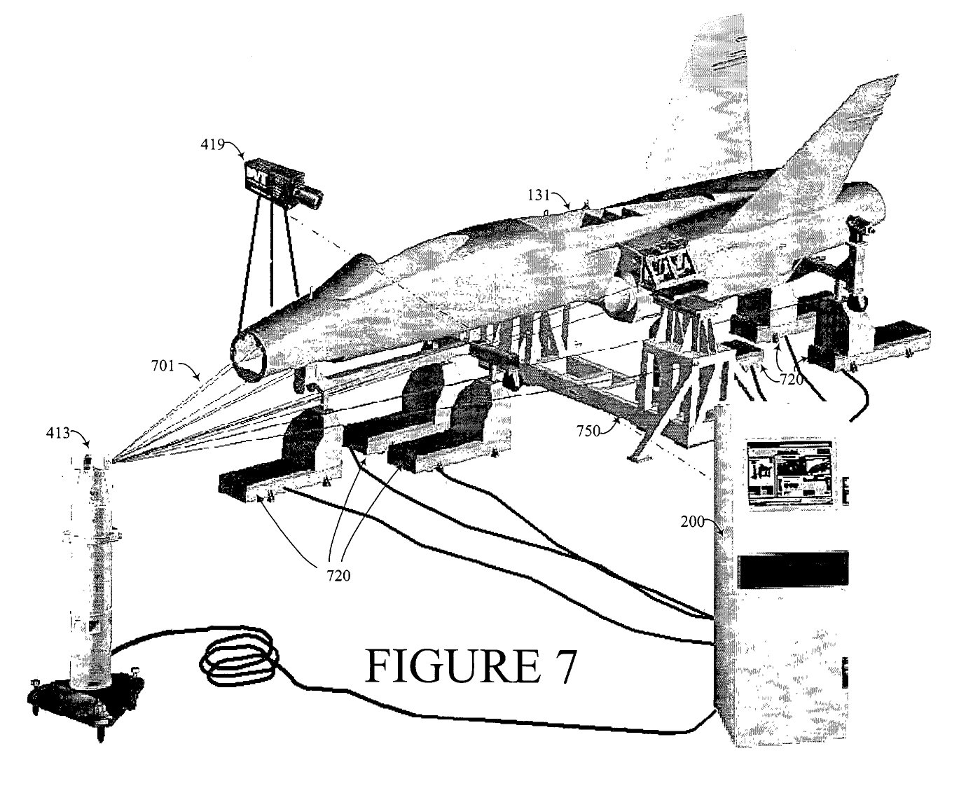

The tooling 701 is appropriately configured, the fixturing is assembled to support the tooling 701, and the fixture with the tooling 701 put in place is set in the operating position at a block 61. The configuration of the tool is checked for accurate placement at a block 63. FIG. 7 portrays the monitoring and placement of the tooling 701. The laser tracker 413 is positioned to monitor movement and placement of the tooling 701, with respect to the airframe 131 and with respect to the “soft tooling” 701 and to report the observed movement and placement to the controller 200. Additionally, however, the industrial video camera 417 allows further precision and cross-checking of the observed movement, assuring that the tooling will not cause further damage rather than repair.

Once the controller 200 and the operator independently and cooperatively align and place of the tooling with respect to the workpiece, the operator, through the controller 200, commands the tooling to begin the selected repair regimen at a block 65. In the course of the tooling operations, at a block 67, the laser tracker 413 and the industrial video camera 417 continue to monitor the tool placement and use in the course of the repair. When the repair is complete, at a block 69, the laser tracker 413 and the industrial video camera 417, examine the repair for completeness and accuracy.

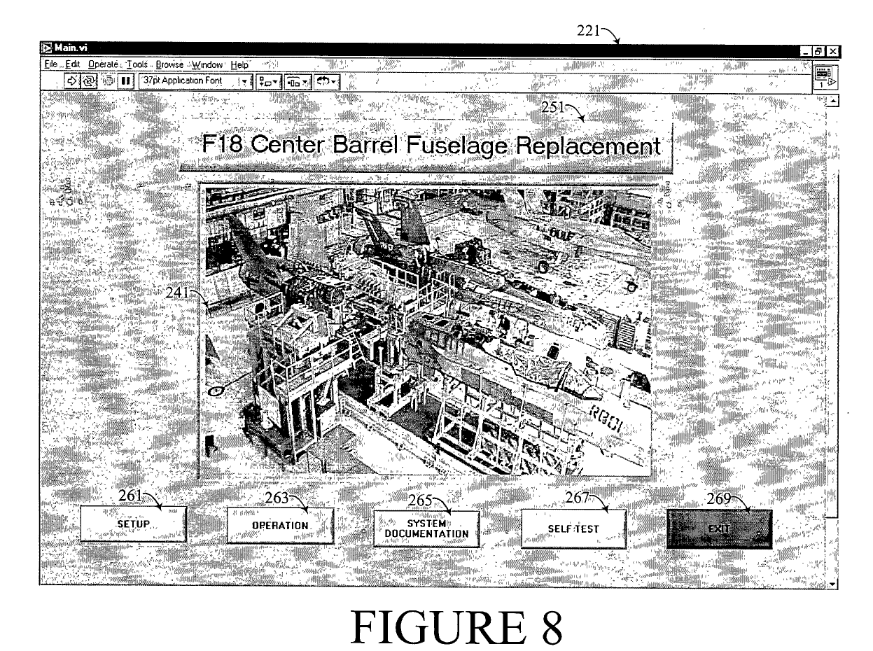

Referring now to FIG. 8, an exemplary splash screen 221 is used to facilitate the interaction between the operator and the controller 200 (FIG. 7) on the operator interface 120 (FIG. 5). The splash screen 221 contains several elements to assist the operator. After measurement of the damaged airframe, the controller suggests a repair regimen in the title window 251, and portrays an exemplary photographic representation of the operation. To examine the proposed operation, the operator is free to review various aspects of the operation, by selecting the appropriate buttons: Setup 251; Operation 263; System Documentation 265; and Self-Test 267. A remaining button, Exit 269 allows the operator to exit the detailed explanation screen 221 to a screen with the several proposed operations for repair or for other distinct screens in the software interface on the controller 200.

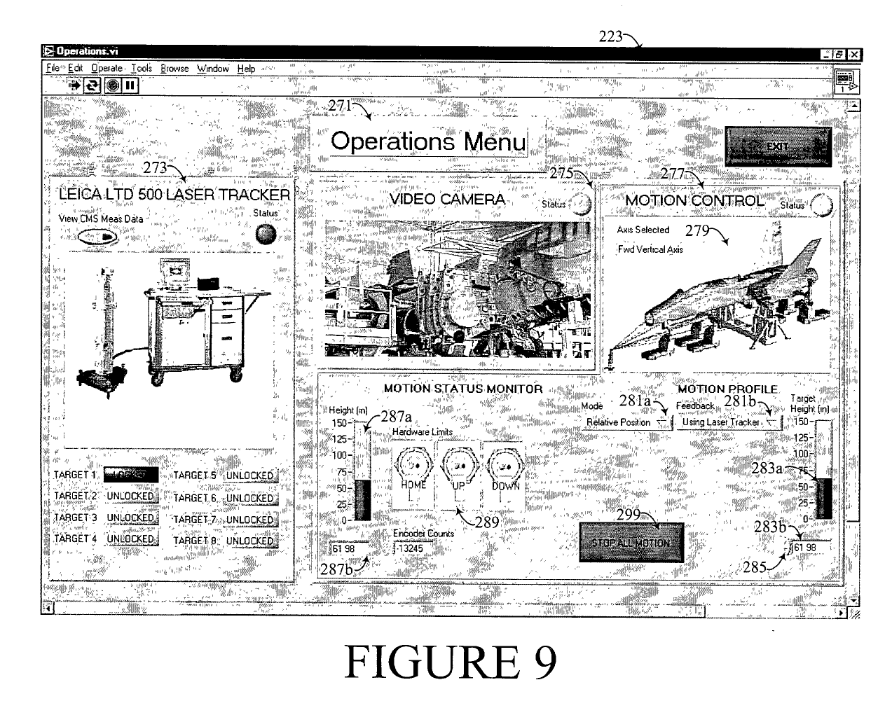

Activation of the Operation button 263 yields the exemplary splash screen 223 portrayed in FIG. 9. As in the earlier exemplary splash screen 221 (FIG. 8), a title window 271 informs the operator of the current menu. On the operations menu, the several distinct tools used for the first stage of operation (in this case, the operation is setting up the “soft tooling”) are portrayed. Each tool is presented in a distinct interactive window. For the laser tracker 413 (FIG. 7), a laser tracker menu 273 is provided. For the industrial video camera 417 (FIG. 7), a video camera menu 275 is provided. For the motion control on the soft tooling 701 (FIG. 7), a motion control menu 277 is provided. The presentation of the various menus is user configurable allowing the operator to configure the menu as the operator feels is most effective.

For each of the menus, appropriate controlling buttons are provided. For example, on the motion control menu 277, the “soft tooling” is controlled either as a unit or as individual jacks on the “soft tooling.” As a unit, the menu 277 has a drop-down menu 279 that allows the controller, under the control of the operator, to move the supported airframe in any of three axes, allowing either displacement or pivotal movement on the selected axis. The motion control menu 277 includes an opportunity to select the feedback sensor 281b and the mode of movement 281a.

The feedback selector 281b operates by calling roll of all possible feedback sensors available: laser tracking 413; industrial video camera 419 photogrammetry; load cells 736 (FIG. 5); skin deflection sensors 738 (FIG. 5); and the like. From this list, the controller 200 generates the drop down list to select the feedback path. Similarly, the mode of movement 281a menu drop down contains selections for movement such as relative position, attitude, absolute position, and the like. The actual position is then reported in analog window 287a and digital window 287b while the target position is reported in analog window 283a and digital window 283b windows with an up/down adjuster set of radio buttons 285 to allow the controller to modify the target position. Additionally, alert windows 289 show yellow as the hardware approaches the limit and turn red as the hardware reaches the limit. A stop motion button 299 suitably dominates the display in red. An exit button 269 returns the operator to the prior menu 221.

As is indicated by the existence of hardware limit warnings, each of the tools on the controller 200 is either normalized or known. The key to modularity is that the individual tools can be trusted and the response is predictable. Additionally, feedback loops have been built into some tools.

Where the machinery isn't completely normalized, each of the identities of the individual tools can be known, with the identity, the response to the control can also be known. Thus, whatever tool is connected to the controller, the controller 200 senses it and compensates for the tool's response to the controller's commands so that in use, every tool will respond in a predictable, usable fashion. With such a compensation system in place, the tools become analogous to the plug-and-play installation of drivers in a computer operating system.

Adding to the knowledge of the performance of particular machines, the controller 200 has the feedback loops that simultaneously feed the controller with information as to the response of tools to commands. Each of these feedback loops will add information about the tool attached. In a presently preferred embodiment of the controller, an artificial intelligence loop continually incorporates the information from all of the feedback loops to refine and further refine the precision obtainable from a particular tool. No matter the tool, the controller 200 gets better and better at retraining the controller 200 to drive the tool.

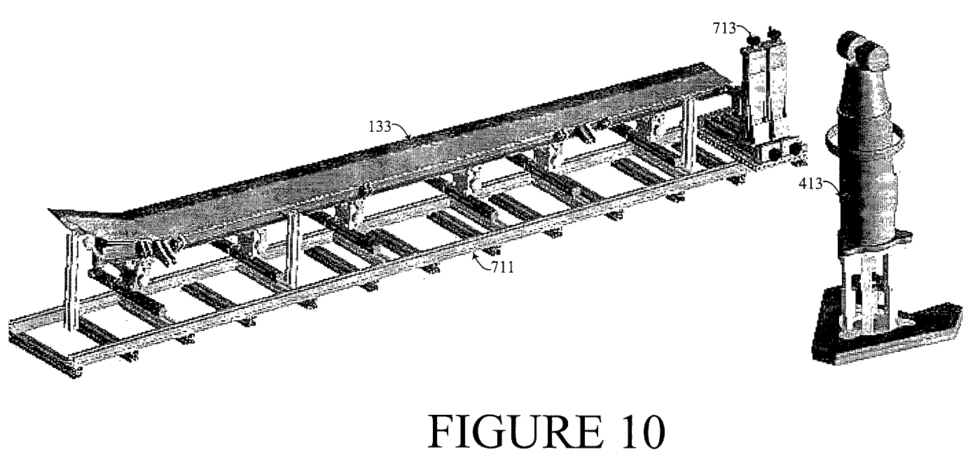

The tool is not limited to driving the “soft tooling” 701. A second use for the controller 200 is portrayed in FIG. 10. A trailing edge flap shroud 133, rests on a reconfigurable modular fixture 711. The laser tracker 413 has surveyed the shroud 133 and sends information back to the controller. A basic tool 713 is built up from Alufix™ along with two standard adjusters in each of two axes.

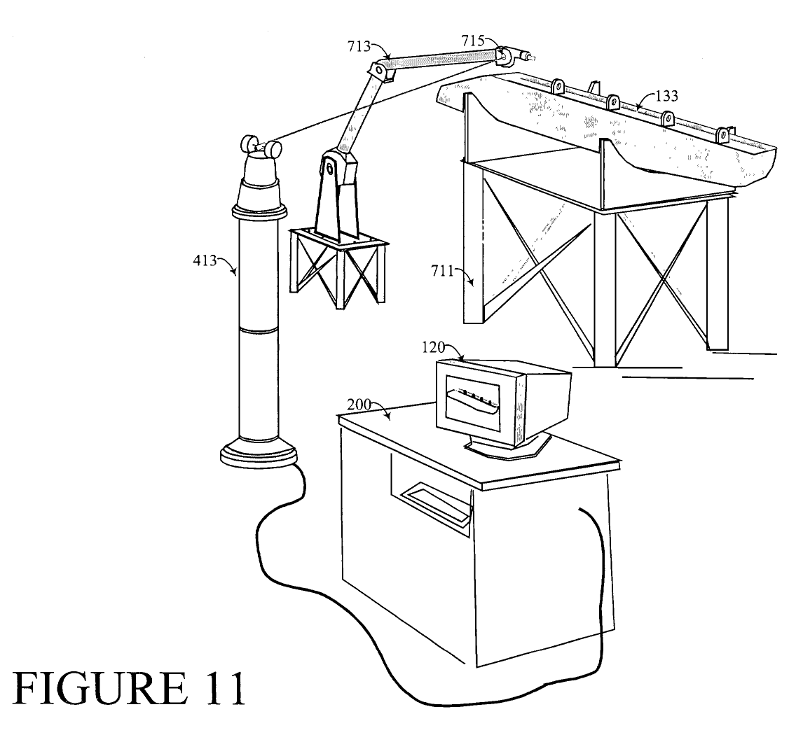

In FIG. 11, the components of the modular tool are shown working on the shroud 133. The laser tracker 413 locates the tool 713 in space with the aid of a reflector 715 placed at the head of the tool 713. The controller 200 moves the head of the tool 713, as the graphic user interface portrays the tool on the screen 120.

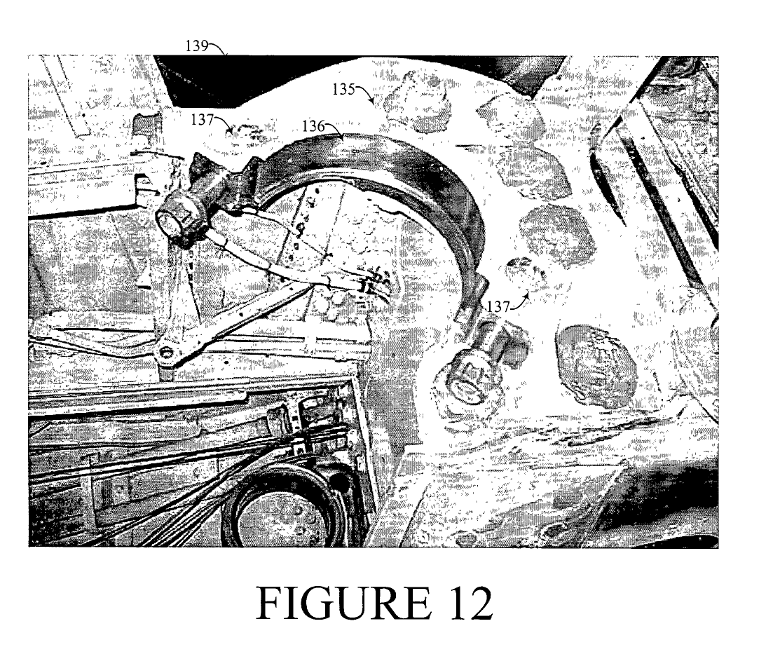

Another application of the modular tool is the repair of a Main Landing Gear, Aft Trunnion Fitting, such as that for a KC-135 aircraft, shown in FIG. 12. The trunnion 135 has worn out of round. A bearing surface 136 must be refaced, requiring application of a grinder to remove the bearing surface 136. Casting marks 137 on the trunnion serve as benchmarks on the trunnion to place it in space. Also visible is the open inspection panel 139 that allows tooling access to the trunion.

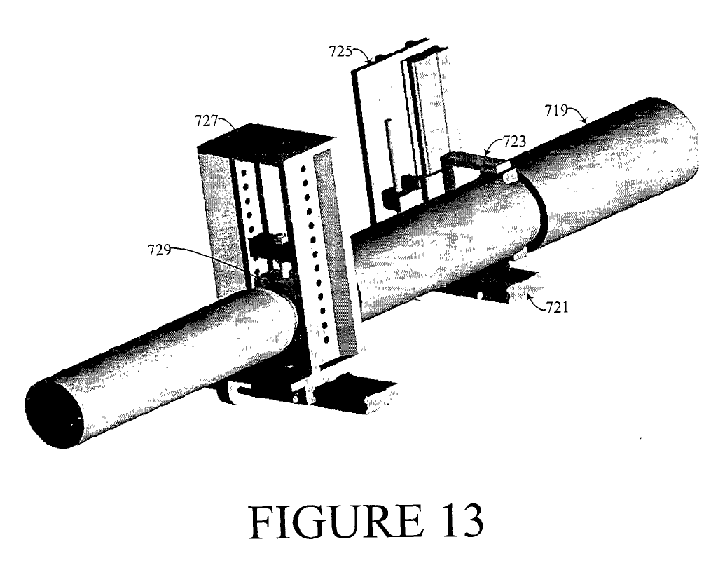

FIG. 13 depicts a forward drive half of a Quackenbush™ Semi-Automatic Series In-Line Drive 719 held by adjustable spherical bearings 729 and linear guides 721, 723, and 725. At this point in the repair process, the operator has selected (likely with assistance of the controller tooling guide 700 (FIG. 2)), the in-line drive 719 as the motivator for the grinding wheel (not shown) to grind the bearing surface of the trunion 135 as well as a fixture suitably built up from Alufix. The rear locator 723 with its linear guides 721 and 725, as well as the forward locator housing 727 with spherical bearings 729, are accessories to the in-line drive 719 and are made to align the drive in mounted applications. The forward locator housing 727 includes the thrust bearings necessary to handle the loads generated by traversing the bearing surface 136 (FIG. 12). Additionally, the forward locator housing 727 is adjustable to allow up to six-degrees of adjustment from a central axis. The rear locator housing 723 with its first linear guide 721 allows up to 4 inch displacement of the central axis along one perpendicular axis and a second linear guide 725 allows up to 4 inch displacement of the central axis along the other perpendicular axis.

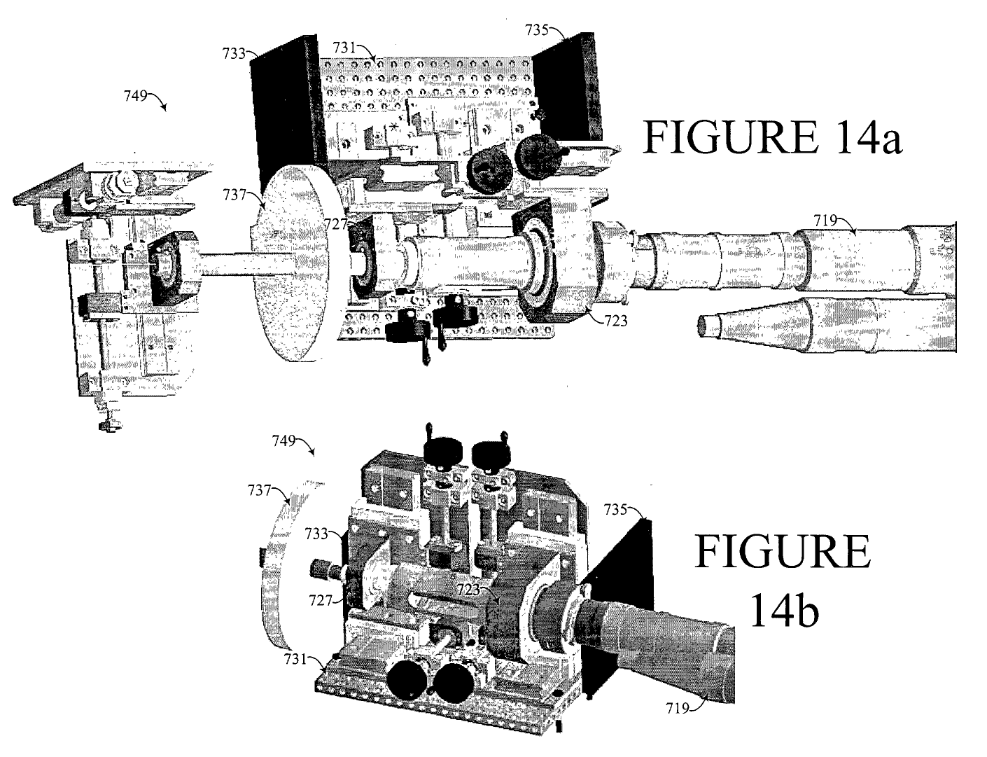

Now the operator, can build up a fixture with modular components. FIG. 14a shows a plan view of a grinder assembly 749 on an Alufix™ fixture and FIG. 14b shows a perspective view of the grinder assembly on the Alufix™ fixture. The grinder assembly 749 depicted in FIGS. 14a and b is readily configured by anchoring the front locator housing 727 and the rear locator housing 723 on an Alufix™ plate 731, along with a forward plate 733, and a rear plate 735. The in-line drive 719 thus drives the grinder wheel 737, while holding the wheel in adjustable relation to the plate 731. If the plate 731 is fixed in space, the grinding wheel 737 can be adjusted in relation to a surface fixed in space.

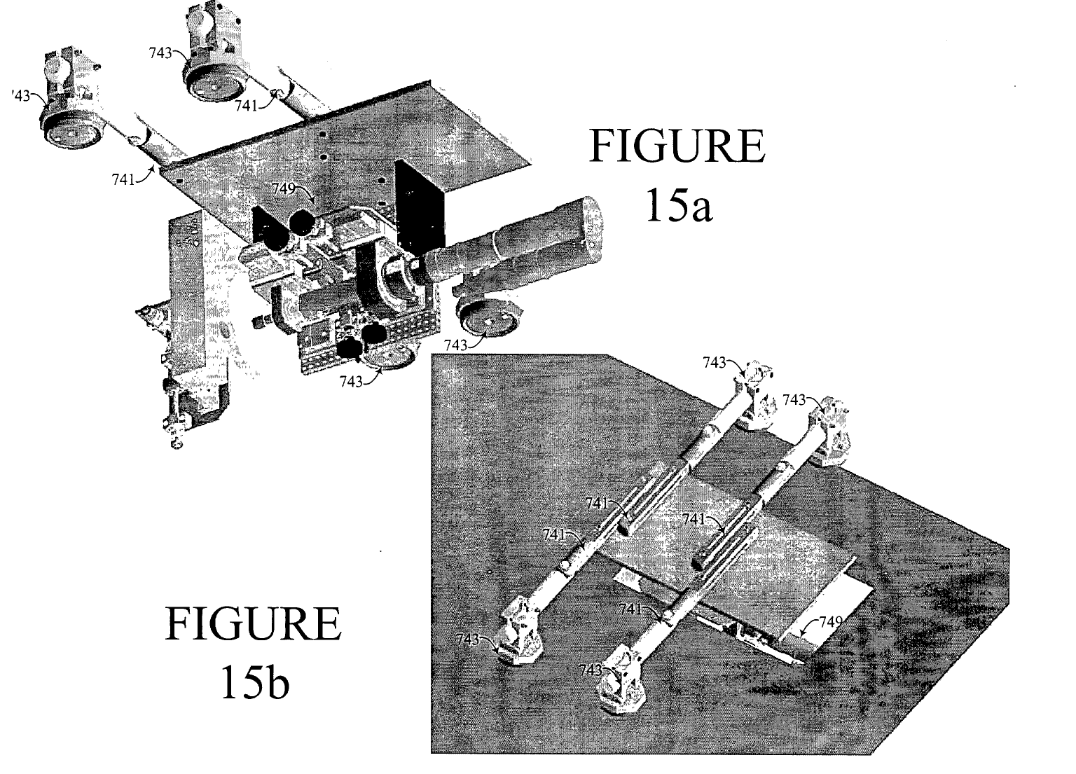

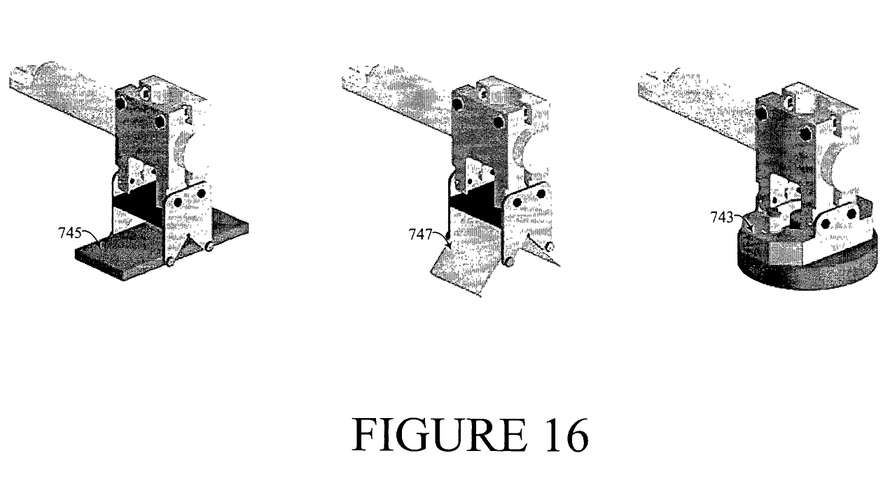

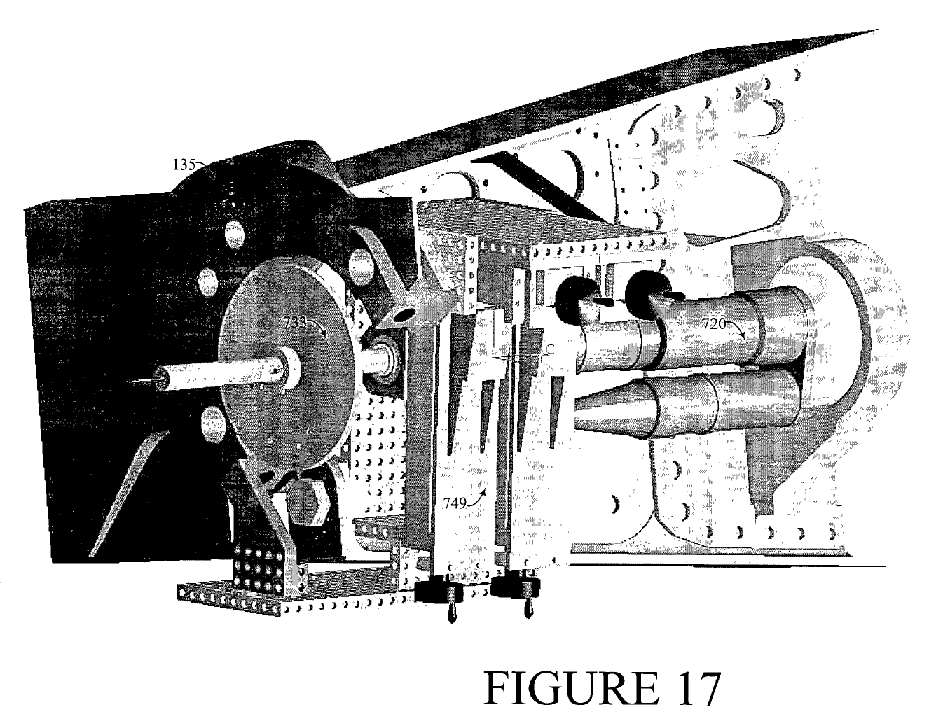

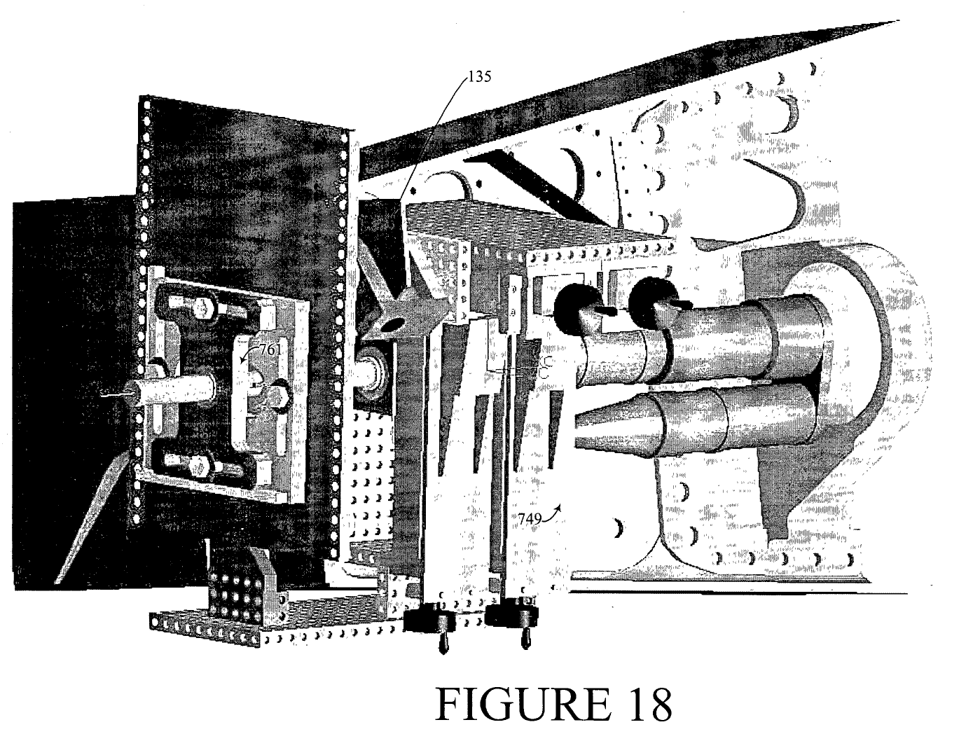

To configure the grinder assembly 749, FIGS. 15a and b show a supporting plate 739 held in the open inspection panel 139 by supporting bars 741 suspended between suction cup pads 743, holding the grinder assembly in fixed relationship to the trunnion 135 (FIG. 12). The fixture is configurable to meet any contingency in the particular repair. FIG. 16, shows, for example, three of many options for the suction cup pads 743. A plate foot 745 is a flat plate that might be secured onto a bulkhead for fixation. An angled foot 747 allows accurate placement on round or angled surfaces. As the tool approaches full configuration and as shown in FIG. 17, the grinder assembly 749 is held in fixed relationship to the damaged trunnion. As configured, the in-line drive is allowed to drive the grinding wheel 737 precisely facing the trunnion 135. The fully configured tool is portrayed in FIG. 18, where addition of the alignment plate with its incorporated alignment bearing 761.

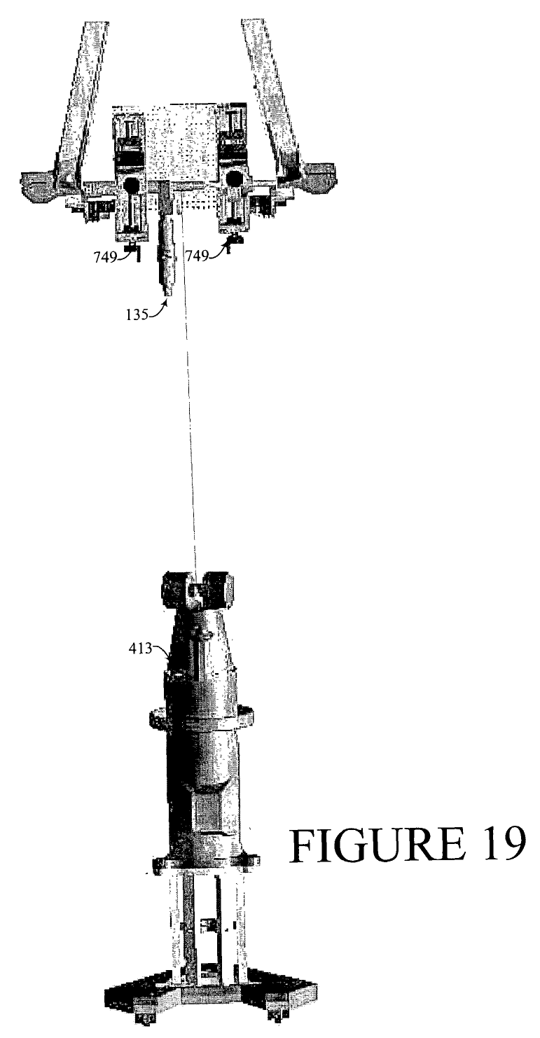

Once fully configured, the tool is ready for use. FIG. 19 shows the laser tracker 413 placed below the landing gear door openings (not shown) scanning the KC-135 aft landing gear trunnion 135. Portions of the grinder assembly 749 are shown (other portions are omitted for clarity of the illustration). The laser tracker 413 precisely locates any fixed point on either the in-line drive or the driven grinding wheel within, for example, 25 μm. The controller 200 can readily monitor the grinding of the trunnion to completion. All of this occurs without removing the trunnion from the aircraft.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A controller for modular tooling, the controller comprising:
a central processing unit;
a scanner port configured to establish and maintain communicative connection between an optical scanner and the central processing unit;
a database in communicative connection with the central processing unit, the database including:
at least one numeric model of an aircraft, assembly, sub-assembly or component part;
at least one standardized procedure for a repair of an aircraft, assembly, sub-assembly or component part; and
a tooling library containing operating characteristics of at least one controllable tool;
an effecter port configured to establish and maintain communicative connection between a controllable tool and the central processing unit; and
an operator interface in communicative connection with the central processing unit.

2. The controller of claim 1, wherein the optical scanner includes a laser tracker.

3. The controller of claim 1, wherein the optical scanner includes at least one 112 concern video camera.

4. The controller of claim 1, wherein the database is remotely located from the controller.

5. The controller of claim 1, wherein the repair database includes at least one configuration of configurable fixturing stored in association with the standardized procedure.

6. The controller of claim 1, wherein the tooling library the characteristics include normalized values for the controllable tools.

7. The controller of claim 1, wherein the operator interface includes a graphic user interface.

8. A software product for controlling modular tooling, the software product comprising:
an interrupt assigned to a scanner port and configured to establish and maintain communicative connection between an optical scanner and a central processing unit;
a database, the database including:
at least one numeric model of an aircraft, assembly, sub-assembly or component part;
at least one standardized procedure for a repair of an aircraft, assembly, sub-assembly or component part; and
a tooling library containing operating characteristics of at least one controllable tool;
an interrupt assigned to an effecter port and configured to establish and maintain communicative connection between a controllable tool and the central processing unit;
an operator interface in communicative connection with the central processing unit;
a first algorithm to compare information received at the interrupt assigned to the scanner with numeric models to produce an assessment of damage to an aircraft; and
a second algorithm to control the controllable tool, based upon the assessment and the operator interface.

9. The software product of claim 8, wherein the optical scanner includes a laser tracker.

10. The software product of claim 8, wherein the optical scanner includes at least one video camera.

11. The software product of claim 8, wherein the database is remotely located from the controller.

12. The software product of claim 8, wherein the database includes at least one configuration of configurable fixturing stored in association with the standardized procedure.

13. The software of claim 8, wherein the database includes normalized values for the controllable tools.

14. The software of claim 8, wherein the operator interface includes a graphic user interface.

15. A method for major structural repair of an aircraft, the method comprising:
surveying a damaged aircraft with an optical scanner;
comparing the surveyed aircraft to a prestored numeric model of aircraft in order to establish variances between the numeric model and the surveyed aircraft;
developing a repair procedure based upon the variances, the repair procedure including using at least one controllable tool;
placing the controllable tool in relation to the damaged aircraft according to the repair procedure;
monitoring the placing of the controllable tool with the optical scanner to establish a displacement;
correcting the placing of the controllable tool based upon the displacement; and
effecting repair according to the developed procedure.

16. The method of claim 15, wherein the optical scanner includes a laser tracker.

17. The method of claim 15, wherein the optical scanner includes a video camera.

18. The method of claim 15, wherein developing of a repair procedure includes referring to a repair database.

19. The method of claim 15, wherein placing a controllable tool includes fixing the damaged aircraft in space.

20. The method of claim 15, wherein effecting the repair includes monitoring by the optical scanner.

21. A portable modular tooling platform for working on a workpiece, the tooling platform comprising:
at least one controllable tool, configured to work on a workpiece;
an optical system configured to sense a location of each of the workpiece and the controllable tool in three-dimensioned space;
a controller communicatively connected to the laser tracker and to the controllable tool; and
a user interface, communicatively connected to the controller and configured to direct the controller to control the controllable tool.

22. The tooling platform of claim 21, wherein the controller is communicatively linked to a database.

23. The tooling platform of claim 22, wherein the database includes at least one numeric model of an aircraft, assembly, sub-assembly or component part.

24. The tooling platform of claim 23, wherein the database includes at least one standardized procedure for a repair of an aircraft, assembly, sub-assembly or component part.

25. The tooling platform of claim 24, wherein the database includes a tooling library containing operating characteristics of at least one controllable tool.

26. The tooling platform of claim 21, wherein the optical system includes a laser tracker.

27. The tooling platform of claim 21, wherein the optical system includes a video camera.
